(19) United States
(12) Patent Application Publication
(10) Pub. No.: US 2026/0184011 A1
(43) Pub. Date: Jul. 2, 2026

(54) AUTONOMOUS ICE SCULPTURE PRINTING SYSTEM AND METHOD

(71) Applicant: Qiqihar Pushi Technology Co., Ltd., Qiqihar (CN)

(72) Inventors: Shipu ZHANG, Qiqihar (CN); Aijia ZHANG, Qiqihar (CN); Shouyi ZHANG, Qiqihar (CN); Linhao XIE, Qiqihar (CN); Yijie NIU, Qiqihar (CN)

(21) Appl. No.: 19/420,200

(22) Filed: Dec. 15, 2025

(30) Foreign Application Priority Data
Dec. 30, 2024 (CN) 202411961232.3

(51) Int. Cl. B29C 64/124; B29C 64/321; B29C 64/393; B33Y 30/00; B33Y 50/02

(52) U.S. Cl. CPC B29C 64/124; B29C 64/321; B29C 64/393; B33Y 30/00; B33Y 50/02

(57) ABSTRACT

The present invention discloses an autonomous ice sculpture printing system and method, including: an ice sculpture printing device and a control system, where the control system is connected to the ice sculpture printing device, and the control system is configured to control the ice sculpture printing device for ice sculpture printing. The ice sculpture printing device includes a base, a purified water tank, a distilled water tank, a nozzle control arm, a filling water nozzle, a printing nozzle, a cooling liquid tank, and an ice sculpture hose; the control system includes: an acquisition module, a processing module, and a control module; the acquisition module is configured to acquire operating data of the ice sculpture printing device.

### CROSS-REFERENCE TO RELATED APPLICATIONS

This application claims priority to Chinese patent application No. 202411961232.3, titled “AUTONOMOUS ICE SCULPTURE PRINTING SYSTEM AND METHOD” filed on 30 Dec. 2024, the entire contents of which are incorporated herein by reference.

### FIELD OF TECHNOLOGY

The present invention relates to the field of ice sculpture printing technology, and in particular to an autonomous ice sculpture printing system and method.

### BACKGROUND

In a conventional ice sculpture production process, the procurement, storage, and transportation of ice sculpture materials require significant investment, and are subject to numerous environmental constraints. Each year, multiple workers need to collaborate to work, and sculptors typically need to manually carve in cold environments. This is not only time-consuming and labor-intensive, but often requires rushing to meet deadlines, which has a serious impact on workers' health. An ambient temperature also has a significant impact on ice sculptures; and even midday sunlight in winter can cause partial melting of the ice sculptures, with greater effects on finely detailed structures. With the advancement of technology, people have begun to explore the use of 3D printing technology to create the ice sculptures, aiming to improve efficiency and accuracy. However, existing 3D printing technologies are mostly used for printing materials such as plastics and metals, and direct application to ice sculpture printing poses numerous challenges. For example, physical properties of ice differ from physical properties of conventional printing materials. Ice melts at room temperature, thus requiring a low-temperature environment to maintain a solid state thereof. In addition, ice sculpture printing demands extremely high precision and stability, necessitating precise control of temperature and water supply during printing. Therefore, the development of an autonomous ice sculpture printing system and method that can effectively address the above problems is of significant practical value and market potential, enabling the ice sculptures to become common features in villages, towns, shopping malls, and along streets, and enhancing the aesthetic appeal of winter cities.

### SUMMARY

The present invention is intended to provide an autonomous ice sculpture printing system and method, to solve the above problems.

The present invention provides an autonomous ice sculpture printing system, including:
an ice sculpture printing device and a control system, where the control system is connected to the ice sculpture printing device, and the control system is configured to control the ice sculpture printing device for ice sculpture printing;
the ice sculpture printing device includes a base, a purified water tank, a distilled water tank, a nozzle control arm, a filling water nozzle, a printing nozzle, a cooling liquid tank, and an ice sculpture hose;
the purified water tank is connected to a first refrigeration unit, the distilled water tank is connected to the first refrigeration unit, the purified water tank is connected to the filling water nozzle through a first water pump, the distilled water tank is connected to the printing nozzle through a second water pump, the filling water nozzle and the printing nozzle are both mounted on an ultracold refrigerator, and the ultracold refrigerator is mounted on the nozzle control arm; the cooling liquid tank is connected to a second refrigeration unit, the cooling liquid tank is connected to the ice sculpture hose through a third water pump, the ice sculpture hose is disposed inside an ice sculpture, and the ice sculpture is mounted on the base;
the control system includes: an acquisition module, a processing module, and a control module;
the acquisition module is configured to acquire operating data of the ice sculpture printing device, the operating data includes a first real-time temperature of the purified water tank and the distilled water tank, a second real-time temperature and real-time flow rate of the printing nozzle, a third real-time temperature of the ice sculpture hose, and a fourth real-time temperature of an environment surrounding the ice sculpture;
the processing module is configured to analyze the operating data and set an operating state of the ice sculpture printing device;
the control module is configured to control the ice sculpture printing device based on the operating state set by the processing module;
the control module is preset with standard operating parameters, where the standard operating parameters include standard operating data of the first refrigeration unit, standard operating data of the second refrigeration unit, standard operating data of the ultracold refrigerator, standard operating data of the first water pump, standard operating data of the second water pump, standard operating data of the third water pump, and standard operating data of the nozzle control arm; and the control module controls initial operating states of the first refrigeration unit, the second refrigeration unit, the ultracold refrigerator, the first water pump, the second water pump, the third water pump, and the nozzle control arm based on the standard operating parameters.

Preferably, a quick connector is disposed at an inlet of the ice sculpture hose, and the cooling liquid tank is connected to the ice sculpture hose through the quick connector.

Preferably, the ice sculpture is disposed in an ice sculpture printing area, an enclosure is disposed around the ice sculpture printing area, and the enclosure is configured to isolate the ice sculpture from an external environment and form a low-temperature environment; and
the ice sculpture includes an ice sculpture shell and an ice sculpture interior, the ice sculpture shell is printed by the printing nozzle, and the ice sculpture interior is printed by the filling water nozzle.

Preferably, the acquisition module includes:
a first temperature sensor, disposed inside the purified water tank and the distilled water tank, and configured to detect the first real-time temperature of the purified water tank and the distilled water tank;
a second temperature sensor, disposed inside the printing nozzle, and configured to detect the second real-time temperature of the printing nozzle;
a flow rate sensor, disposed inside the printing nozzle, and configured to detect the real-time flow rate of the printing nozzle;
a third temperature sensor, disposed inside the ice sculpture hose, and configured to detect the third real-time temperature of the ice sculpture hose; and
a fourth temperature sensor, disposed around the ice sculpture, and configured to detect the fourth real-time temperature of the environment surrounding the ice sculpture.

Preferably, the processing module is configured to analyze the operating data and set an operating state of the ice sculpture printing device, including:
the first real-time temperature is an average value of a water temperature in the purified water tank and a water temperature in the distilled water tank;
a cooling power of the first refrigeration unit is set based on the first real-time temperature;
a cooling power of the ultracold refrigerator is set based on the second real-time temperature;
an operating power of the second water pump is set based on the real-time flow rate; and
a cooling power of the second refrigeration unit is set based on the third real-time temperature and the fourth real-time temperature.

Preferably, the processing module sets the cooling power of the first refrigeration unit based on the first real-time temperature, including:
determining whether the first real-time temperature is within a range of [0° C., 5° C.]; and skipping adjusting the cooling power of the first refrigeration unit if the first real-time temperature is within the range of [0° C., 5° C.]; or
determining a first temperature difference between the first real-time temperature and 0° C., and setting the cooling power of the first refrigeration unit based on the first temperature difference if the first real-time temperature is not within the range of [0° C., 5° C.].

Preferably, the processing module sets the cooling power of the ultracold refrigerator based on the second real-time temperature, including:
comparing the second real-time temperature with −5° C.; and skipping adjusting the cooling power of the ultracold refrigerator if the second real-time temperature is lower than or equal to −5° C.; or
determining a second temperature difference between the second real-time temperature and −5° C., and setting the cooling power of the ultracold refrigerator based on the second temperature difference if the second real-time temperature is higher than −5° C.

Preferably, the processing module sets the operating power of the second water pump based on the real-time flow rate, including:
determining a flow rate difference between the real-time flow rate and a preset flow rate;
setting the operating power of the second water pump based on the flow rate difference,
where a first flow rate difference, a second flow rate difference, and a third flow rate difference are preset, and the first flow rate difference, the second flow rate difference, and the third flow rate difference increase in turn;
setting the operating power of the second water pump based on a relationship among the flow rate difference and the first flow rate difference, the second flow rate difference, and the third flow rate difference;
setting the operating power of the second water pump to a first operating power P1 if the flow rate difference is less than the first flow rate difference;
setting the operating power of the second water pump to a second operating power P2 if the flow rate difference is greater than or equal to the first flow rate difference and less than the second flow rate difference;
setting the operating power of the second water pump to a third operating power P3 if the flow rate difference is greater than or equal to the second flow rate difference and less than the third flow rate difference; or
setting the operating power of the second water pump to a fourth operating power P4 if the flow rate difference is greater than or equal to the third flow rate difference, where P1<P2<P3<P4.

Preferably, the processing module sets the cooling power of the second refrigeration unit based on the third real-time temperature and the fourth real-time temperature, including:
determining whether the fourth real-time temperature is less than 0° C.; if the fourth real-time temperature is lower than or equal to 0° C., determining a third temperature difference between the third real-time temperature and a standard temperature, and determining the cooling power of the second refrigeration unit based on the third temperature difference; or
if the fourth real-time temperature is greater than 0° C., determining a third temperature difference between the third real-time temperature and a standard temperature, determining a temperature sum between the third temperature difference and the fourth real-time temperature, and determining the cooling power of the second refrigeration unit based on the temperature sum.

The present invention also discloses an autonomous ice sculpture printing method, used in the above-mentioned autonomous ice sculpture printing system, and including:
acquiring operating data of an ice sculpture printing device, where the operating data includes a first real-time temperature of a purified water tank, a second real-time temperature and a real-time flow rate of a printing nozzle, a third real-time temperature of an ice sculpture hose, and a fourth real-time temperature of an environment surrounding an ice sculpture;
analyzing the operating data to set an operating state of the ice sculpture printing device; and
controlling the ice sculpture printing device based on the set operating state,
where the analyzing the operating data to set an operating state of the ice sculpture printing device includes:
a cooling power of the first refrigeration unit is set based on the first real-time temperature;
a cooling power of the ultracold refrigerator is set based on the second real-time temperature;
an operating power of the second water pump is set based on the real-time flow rate; and
a cooling power of the second refrigeration unit is set based on the third real-time temperature and the fourth real-time temperature.

Compared with the prior art, beneficial effects of the present invention are as follows: According to the present invention, automatic control of the ice sculpture printing device is implemented by the control system, improving production efficiency, greatly reducing manufacturing costs for the ice sculpture, and enabling a longer exhibition period for the ice sculpture. The ice sculpture can be produced anywhere without relying on a sculptor, and the quality of the ice sculpture is greatly improved. Through real-time acquisition and analysis of the operating data, parameters such as the cooling power of the refrigeration unit and the operating power of the water pump can be precisely set, thereby enabling precise control of the ice sculpture printing process. Precise control of the refrigeration unit and the water pump can prevent excessive cooling and excessive pumping, thus reducing energy consumption and minimizing environmental impact. Precise control of the ice sculpture printing process ensures the stability and consistency of ice sculpture quality, improving a product pass rate. The system can automatically adjust an operating state according to different ice sculpture printing requirements, offering strong adaptability.

### BRIEF DESCRIPTION OF THE DRAWINGS

To more clearly illustrate technical solutions in embodiments of the present invention or the prior art, drawings required for the description of the embodiments or prior art are briefly introduced below. It is obvious that the drawings described below are merely embodiments of the present invention. For those skilled in the art, other drawings can also be obtained based on the provided drawings without creative effort.

FIG. 1 is a schematic structural diagram of an ice sculpture printing device in an autonomous ice sculpture printing system according to the present invention;

FIG. 2 is a schematic diagram of a connection structure of a cooling liquid tank according to an embodiment of the present invention; and

FIG. 3 is a schematic flow diagram of an autonomous ice sculpture printing method according to the present invention.

### DESCRIPTION OF THE EMBODIMENTS

The following clearly and completely describes technical solutions in embodiments of this application with reference to accompanying drawings in the embodiments of this application. Apparently, the described embodiments are only a part rather than all of the embodiments of this application. All other embodiments obtained by those skilled in the art based on the embodiments of this application without creative efforts shall fall within the protection scope of this application.

In the descriptions of this application, it should be understood that an orientation or a position relationship indicated by the terms “center”, “above”, “below”, “front”, “back”, “left”, “right”, “vertical”, “horizontal”, “top”, “bottom”, “inside”, “outside”, and the like is based on an orientation or a position relationship shown in the accompanying drawings, and is merely intended for ease of describing this application and simplifying description, but does not indicate or imply that a described apparatus or element needs to have a specific orientation or be constructed and operated in a specific orientation. Therefore, such terms shall not be understood as a limitation on this application.

Terms “first” and “second” are only used for descriptive purposes and cannot be understood as indicating or implying relative importance or implying the number of technical features indicated. Therefore, a feature limited by “first” or “second” may explicitly or implicitly include one or more features. In the description of this application, unless otherwise stated, “multiple” means two or more than two.

In the description of this application, it should be noted that, unless otherwise expressly stipulated and defined, terms “mount”, “join” , “connect”, should be understood in a broad sense. For example, “connection” may be a firm connection, a detachable connection, or an integral connection; may be a mechanical connection, or an electrical connection; or may be a direct connection, an indirect connection through an intermediate medium, or a connection between two elements. Those skilled in the art can understand specific meanings of the terms in this application based on specific situations.

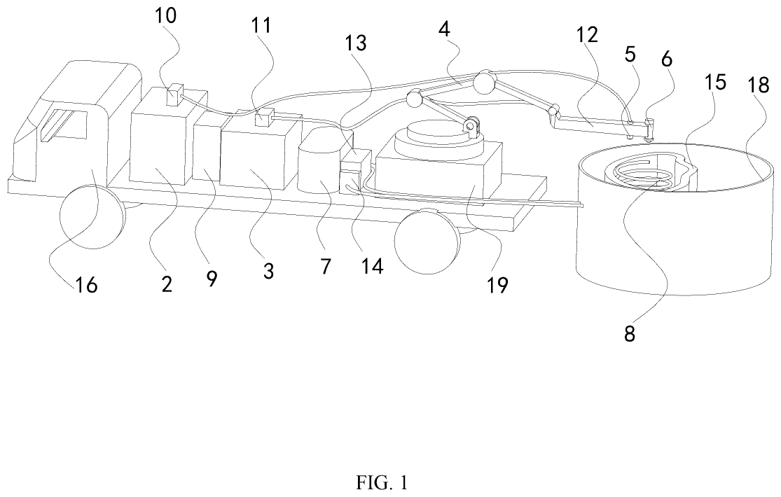

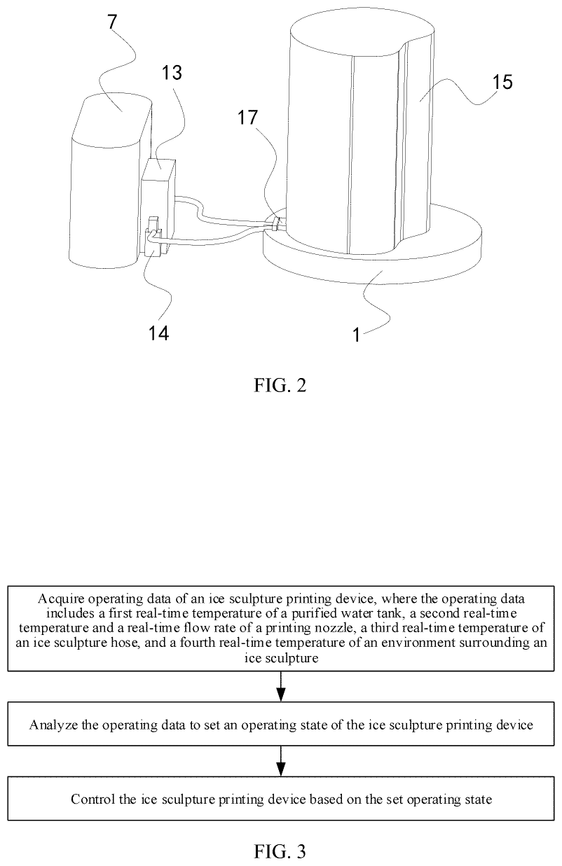

As shown in FIG. 1 and FIG. 2, the present invention provides an autonomous ice sculpture printing system, including:
an ice sculpture printing device and a control system 19, where the control system 19 is connected to the ice sculpture printing device, and the control system 19 is configured to control the ice sculpture printing device for ice sculpture printing.

The ice sculpture printing device includes a base 1, a purified water tank 2, a distilled water tank 3, a nozzle control arm 4, a filling water nozzle 5, a printing nozzle 6, a cooling liquid tank 7, and an ice sculpture hose 8.

The purified water tank 2 is connected to a first refrigeration unit 9, the distilled water tank 3 is connected to the first refrigeration unit 9, the purified water tank 2 is connected to the filling water nozzle 5 through a first water pump 10, the distilled water tank 3 is connected to the printing nozzle 6 through a second water pump 11, the filling water nozzle 5 and the printing nozzle 6 are both mounted on an ultracold refrigerator 12, and the ultracold refrigerator 12 is mounted on the nozzle control arm 4. The cooling liquid tank 7 is connected to a second refrigeration unit 13, the cooling liquid tank 7 is connected to the ice sculpture hose 8 through a third water pump 14, the ice sculpture hose 8 is disposed inside an ice sculpture 15, and the ice sculpture 15 is mounted on the base 1.

The control system 19 includes: an acquisition module, a processing module, and a control module.

The acquisition module is configured to acquire operating data of the ice sculpture printing device, the operating data includes a first real-time temperature of the purified water tank 2 and the distilled water tank 3, a second real-time temperature and real-time flow rate of the printing nozzle 6, a third real-time temperature of the ice sculpture hose 8, and a fourth real-time temperature of an environment surrounding the ice sculpture 15.

The processing module is configured to analyze the operating data and set an operating state of the ice sculpture printing device.

The control module is configured to control the ice sculpture printing device based on the operating state set by the processing module.

The control module is preset with standard operating parameters, where the standard operating parameters include standard operating data of the first refrigeration unit 9, standard operating data of the second refrigeration unit 13, standard operating data of the ultracold refrigerator 12, standard operating data of the first water pump 10, standard operating data of the second water pump 11, standard operating data of the third water pump 14, and standard operating data of the nozzle control arm 4. The control module controls initial operating states of the first refrigeration unit 9, the second refrigeration unit 13, the ultracold refrigerator 12, the first water pump 10, the second water pump 11, the third water pump 14, and the nozzle control arm 4 based on the standard operating parameters.

It can be understood that cooling liquid stored in the cooling liquid tank 7 is saline, and a concentration of the saline can be adjusted as needed. When a salt substance (such as sodium chloride) is added to water, a freezing point of the saline decreases. This is because the dissolution of salt interferes with a structure of water molecules, making it more difficult for the water molecules to form a solid structure at low temperatures, thereby increasing a difficulty in freezing. When the concentration of saline is low, the decrease in a freezing temperature is not significant, but as the concentration of saline increases, the freezing temperature gradually decreases. When the concentration of saline reaches a specific level, the freezing temperature can be reduced to below zero degrees Celsius. Therefore, introducing saline into the hose can not only cool the ice sculpture 15 but also prevent the cooling liquid inside the hose from freezing. The refrigeration unit and the ultracold refrigerator 12 can be driven by an external electrical power supply.

It can be learned that the ice sculpture printing device is mounted on a self-propelled chassis 16, such as a truck or another mobile apparatus, which facilitates the movement of the ice sculpture printing device to print the ice sculpture 15 at a fixed location. The mobile apparatus is battery-powered.

Dyes can be added to the distilled water tank 3 and the purified water tank 2, allowing the ice sculpture 15 to display brilliant colors. Further, a light source can be pre-embedded inside the ice sculpture 15, enabling the ice sculpture 15 to be even more colorful. Distilled water is used as a raw material for printing an ice shell on a surface of the ice sculpture 15, and purified water is a material for filling the interior of the ice sculpture 15.

In some embodiments of this application, a quick connector 17 is provided at an inlet of the ice sculpture hose 8, and the cooling liquid tank 7 is connected to the ice sculpture hose 8 through the quick connector 17.

In some embodiments of this application, the ice sculpture 15 is disposed in an ice sculpture printing area, and an enclosure 18 is disposed around the ice sculpture printing area. The enclosure 18 is configured to isolate the ice sculpture 15 from an external environment and form a low-temperature environment.

The ice sculpture 15 includes an ice sculpture shell and an ice sculpture interior. The ice sculpture shell is printed by the printing nozzle 6, and the ice sculpture interior is printed by the filling water nozzle 5.

The enclosure is made of a thermal insulation material, which can effectively isolate the ice sculpture from the external environment, thereby reducing the impact of an external temperature on the ice sculpture. A height and structural design of the enclosure are proper, ensuring both the stability of the ice sculpture and the formation of a low-temperature environment.

In some embodiments of this application, the acquisition module includes: a first temperature sensor, disposed in the purified water tank and the distilled water tank and configured to detect the first real-time temperature in the purified water tank and the distilled water tank; a second temperature sensor, disposed in the printing nozzle and configured to detect the second real-time temperature of the printing nozzle; a flow rate sensor, disposed in the printing nozzle and configured to detect the real-time flow rate of the printing nozzle; a third temperature sensor, disposed in the ice sculpture hose and configured to detect the third real-time temperature of the ice sculpture hose; and a fourth temperature sensor, disposed around the ice sculpture and configured to detect the fourth real-time temperature of the environment surrounding the ice sculpture.

In some embodiments of this application, the processing module is configured to analyze the operating data and set an operating state of the ice sculpture printing device, including: the first real-time temperature is an average value of a water temperature in the purified water tank and a water temperature in the distilled water tank; a cooling power of the first refrigeration unit is set based on the first real-time temperature; a cooling power of the ultracold refrigerator is set based on the second real-time temperature; an operating power of the second water pump is set based on the real-time flow rate; and a cooling power of the second refrigeration unit is set based on the third real-time temperature and the fourth real-time temperature.

The processing module is a crucial component of the ice sculpture printing device, responsible for real-time monitoring and adjustment of the operating state of the device to ensure the accuracy and stability of a printing process. This module acquires key data through a series of sensors and performs intelligent analysis and decision-making based on the data.

First, the processing module calculates an average temperature of the water in the purified water tank and the distilled water tank, which is referred to as the first real-time temperature. This temperature is critical to the ice sculpture printing process, as this temperature affects a solidification speed and quality of a material. Based on the first real-time temperature, the processing module automatically adjusts the cooling power of the first refrigeration unit to maintain the water temperature within an ideal range, thereby ensuring that a printed ice sculpture has the required fineness and structural stability.

Secondly, the processing module monitors another key parameter, namely, the second real-time temperature, which is a temperature of the ultracold refrigerator. The ultracold refrigerator is responsible for cooling the water to a temperature close to a freezing point for printing use. The processing module sets the cooling power of the ultracold refrigerator based on this temperature, ensuring that the water temperature remains at an optimal state for high-quality ice sculpture printing.

The real-time flow rate is also one of parameters that the processing module needs to monitor. The processing module sets the operating power of the second water pump based on a current water flow rate. A power of the water pump needs to be precisely controlled to ensure that water is delivered to the printing nozzle at a proper speed and pressure, which is crucial for printing a fine ice sculpture structure.

Finally, the processing module also monitors the third real-time temperature and the fourth real-time temperature, both of which represent temperatures of different environments or parts of the device. The processing module sets the cooling power of the second refrigeration unit based on these two temperature values. The second refrigeration unit is usually configured to regulate an ambient temperature of a printing area, to prevent heat generated during printing from affecting the quality of the ice sculpture.

Through real-time monitoring and intelligent analysis, the processing module ensures that the ice sculpture printing device operates in the best state, thereby implementing high-quality ice sculpture printing output.

In some embodiments of this application, the processing module sets the cooling power of the first refrigeration unit based on the first real-time temperature, including: determining whether the first real-time temperature is within a range of [0° C., 5° C.]; and skipping adjusting the cooling power of the first refrigeration unit if the first real-time temperature is within the range of [0° C., 5° C.]; or determining a first temperature difference between the first real-time temperature and 0° C., and setting the cooling power of the first refrigeration unit based on the first temperature difference if the first real-time temperature is not within the range of [0° C., 5° C.].

In a temperature control system, the processing module is responsible for adjusting an operating state of a refrigeration device based on real-time temperature data. Specifically, the processing module monitors and acquires a current temperature of an environment where the first refrigeration unit is located in real time, namely, the first real-time temperature. Based on the temperature data, the processing module performs a series of determining and calculations to ensure that a power output of the refrigeration device meets actual requirements.

First, the processing module checks whether the first real-time temperature is within a preset temperature range, namely, [0° C., 5° C.]. If the first real-time temperature falls within this range, the processing module does not make any adjustment to the cooling power of the first refrigeration unit. This means that the refrigeration device maintains a current operating state and continues cooling at an existing power output.

However, if the first real-time temperature is not within the range of [0° C., 5° C.], the processing module takes further measures. In this case, the processing module calculates a difference between the first real-time temperature and 0° C., namely, the first temperature difference. This difference reflects a degree of deviation between a current temperature and a target temperature. The processing module sets the cooling power of the first refrigeration unit based on this difference. In this way, the processing module can ensure that the first refrigeration unit can operate at a proper power under different temperature conditions, thereby achieving the best refrigeration effect.

In summary, the processing module can flexibly adjust the cooling power of the first refrigeration unit through real-time monitoring and calculation, to be adapted to changes in the ambient temperature and ensure that the refrigeration device operates efficiently and stably under different circumstances.

In some embodiments of this application, the processing module sets the cooling power of the ultracold refrigerator based on the second real-time temperature, including: comparing the second real-time temperature with −5° C.; skipping adjusting the cooling power of the ultracold refrigerator if the second real-time temperature is lower than or equal to −5° C.; and determining the second temperature difference between the second real-time temperature and −5° C., and setting the cooling power of the ultracold refrigerator based on the second temperature difference if the second real-time temperature is higher than −5° C.

In some embodiments of this application, that the processing module sets the operating power of the second water pump based on the real-time flow rate includes: determining a flow rate difference between the real-time flow rate and a preset flow rate; setting the operating power of the second water pump based on the flow rate difference, where a first flow rate difference, a second flow rate difference, and a third flow rate difference are preset, and the first flow rate difference, the second flow rate difference, and the third flow rate difference increase in turn; setting the operating power of the second water pump based on a relationship among the flow rate difference and the first flow rate difference, the second flow rate difference, and the third flow rate difference; setting the operating power of the second water pump to a first operating power P1 if the flow rate difference is less than the first flow rate difference; setting the operating power of the second water pump to a second operating power P2 if the flow rate difference is greater than or equal to the first flow rate difference and less than the second flow rate difference; setting the operating power of the second water pump to the third operating power P3 if the flow rate difference is greater than or equal to the second flow rate difference and less than a third flow rate difference; setting the operating power of the second water pump to a fourth operating power P4 if the flow rate difference is greater than or equal to the third flow rate difference; where P1<P2<P3<P4.

In some embodiments of this application, that the processing module sets the cooling power of the second refrigeration unit based on the third real-time temperature and the fourth real-time temperature includes: determining whether the fourth real-time temperature is less than 0° C.; if the fourth real-time temperature is lower than or equal to 0° C., determining a third temperature difference between the third real-time temperature and a standard temperature, and determining the cooling power of the second refrigeration unit based on the third temperature difference; or if the fourth real-time temperature is greater than 0° C., determining the third temperature difference between the third real-time temperature and the standard temperature, determining a temperature sum between the third temperature difference and the fourth real-time temperature, and determining the cooling power of the second refrigeration unit based on the temperature sum.

The processing module sets the cooling power of the second refrigeration unit based on the third real-time temperature and the fourth real-time temperature, with a specific operation as follows: first, it is determined whether the fourth real-time temperature is less than 0° C. If the fourth real-time temperature is lower than or equal to 0° C., this indicates that an ambient temperature around the ice sculpture is extremely low. In this case, the processing module calculates the third temperature difference between the third real-time temperature and the preset standard temperature. Then, the cooling power of the second refrigeration unit is determined based on this third temperature difference to ensure that the system operates within a safe temperature range while preventing unnecessary energy consumption.

If the fourth real-time temperature is greater than 0° C., this indicates that the ambient temperature around the ice sculpture is relatively high, which may cause the ice sculpture to melt and require cooling of the ice sculpture. In this case, the processing module also calculates the third temperature difference between the third real-time temperature and the standard temperature. In addition, the processing module calculates the temperature sum between the third temperature difference and the fourth real-time temperature. This temperature sum reflects a degree of deviation between a current temperature state and an ideal state. Based on this temperature sum, the processing module determines the cooling power of the second refrigeration unit to ensure efficient operation of the system while maintaining the temperature within a set range.

In this way, the processing module can intelligently adjust the cooling power of the second refrigeration unit based on real-time temperature data, ensuring both cooling efficiency and safe and stable operation of the system.

As shown in FIG. 3, the present invention discloses an autonomous ice sculpture printing method, which is used in the above autonomous ice sculpture printing system, including:
acquiring operating data of an ice sculpture printing device, where the operating data includes a first real-time temperature of a purified water tank, a second real-time temperature and a real-time flow rate of a printing nozzle, a third real-time temperature of an ice sculpture hose, and a fourth real-time temperature of an environment surrounding an ice sculpture;
analyzing the operating data to set an operating state of the ice sculpture printing device; and
controlling the ice sculpture printing device based on the set operating state.

The analyzing the operating data to set an operating state of the ice sculpture printing device includes: setting a cooling power of a first refrigeration unit based on the first real-time temperature; setting a cooling power of an ultracold refrigerator based on the second real-time temperature; setting an operating power of a second water pump based on the real-time flow rate; and setting a cooling power of a second refrigeration unit based on the third real-time temperature and the fourth real-time temperature.

It can be learned that an operating state of the device can be controlled more precisely by acquiring and analyzing the operating data of the ice sculpture printing device in real time, thereby improving the efficiency of ice sculpture printing. For example, setting the cooling power of the first refrigeration unit based on the first real-time temperature and setting the cooling power of the ultracold refrigerator based on the second real-time temperature can ensure that water enters the printing nozzle at a proper temperature, thus preventing a printing quality problem caused by an extremely high or low water temperature.

The fourth real-time temperature of the environment surrounding the ice sculpture is monitored, so that the cooling power of the second refrigeration unit can be adjusted based on the ambient temperature, thereby ensuring that the ice sculpture remains stable within a specific temperature range and preventing melting or deformation caused by changes in the ambient temperature.

Through real-time monitoring and analysis of the operating data of the ice sculpture printing device, precise control of the operating state of the device can be implemented, preventing energy waste. For example, setting the operating power of the second water pump based on the real-time flow rate can prevent the water pump from overworking, thereby saving electrical energy.

A degree of device wear can be reduced and the service life of the device can be extended by real-time monitoring and adjusting the operating state of the ice sculpture printing device. For example, setting the cooling power of the second refrigeration unit based on the third real-time temperature and the fourth real-time temperature can prevent the refrigeration unit from long-term high-load operation, thereby reducing a failure rate.

In the present invention, an automated control system is used for real-time monitoring and adjustment of the ice sculpture printing device, reducing a difficulty in manual operation and improving production efficiency. In addition, the system can automatically adjust the operating state of the device based on different ice sculpture printing requirements, thus possessing strong adaptability and flexibility.

Finally, it should be noted that the above embodiments are only intended to illustrate technical solutions of the present invention and not to limit the present invention. Although the present invention has been described in detail with reference to preferred embodiments, those skilled in the art should understand that modifications or equivalent replacements can still be made to the technical solutions of the present invention, and such modifications or equivalent replacements shall not cause modified technical solutions to depart from the spirit and scope of the present invention.

The system provided in the above embodiments is only described by way of example based on the division of the above functional modules. In practical applications, the above functions can be distributed and completed by different functional modules as needed. To be specific, the modules or steps in the embodiments of the present invention may be further decomposed or combined. For example, the modules in the above embodiments may be merged into one module or further split into multiple sub-modules to accomplish all or part of the functions described above. Names of the modules and steps related to the embodiments of the present invention are only for distinguishing each module or step and shall not be construed as improper limitations on the present invention.

Those skilled in the art should be able to recognize that the modules and method steps of the examples described in connection with the embodiments disclosed herein can be implemented in electronic hardware, computer software, or a combination of both. The programs corresponding to the software modules and method steps can be placed in a random access memory (RAM), a memory, a read-only memory (ROM), an electrically erasable programmable ROM, a register, a hard disk, a removable disk, a CD-ROM, or any other form of a storage medium known in the art. To clearly illustrate interchangeability of electronic hardware and software, components and steps of the examples have been generally described in terms of functions in the above description. Whether these functions are performed by the electronic hardware or software depends on specific application and design constraints of the technical solutions. Those skilled in the art can use different methods to implement the described functions for each specific application, but such implementations should not be considered as exceeding the scope of the present invention.

What is claimed is:

1. An autonomous ice sculpture printing system, comprising:
an ice sculpture printing device and a control system, wherein the control system is connected to the ice sculpture printing device, and the control system is configured to control the ice sculpture printing device for ice sculpture printing;
the ice sculpture printing device comprises a base, a purified water tank, a distilled water tank, a nozzle control arm, a filling water nozzle, a printing nozzle, a cooling liquid tank, and an ice sculpture hose;
the purified water tank is connected to a first refrigeration unit, the distilled water tank is connected to the first refrigeration unit, the purified water tank is connected to the filling water nozzle through a first water pump, the distilled water tank is connected to the printing nozzle through a second water pump, the filling water nozzle and the printing nozzle are both mounted on an ultracold refrigerator, and the ultracold refrigerator is mounted on the nozzle control arm; the cooling liquid tank is connected to a second refrigeration unit, the cooling liquid tank is connected to the ice sculpture hose through a third water pump, the ice sculpture hose is disposed inside an ice sculpture, and the ice sculpture is mounted on the base;
the control system comprises: an acquisition module, a processing module, and a control module;
the acquisition module is configured to acquire operating data of the ice sculpture printing device, wherein the operating data comprises a first real-time temperature of the purified water tank and the distilled water tank, a second real-time temperature and real-time flow rate of the printing nozzle, a third real-time temperature of the ice sculpture hose, and a fourth real-time temperature of an environment surrounding the ice sculpture;
the processing module is configured to analyze the operating data and set an operating state of the ice sculpture printing device;
the control module is configured to control the ice sculpture printing device based on the operating state set by the processing module;
the control module is preset with standard operating parameters, wherein the standard operating parameters comprise standard operating data of the first refrigeration unit, standard operating data of the second refrigeration unit, standard operating data of the ultracold refrigerator, standard operating data of the first water pump, standard operating data of the second water pump, standard operating data of the third water pump, and standard operating data of the nozzle control arm; and the control module controls initial operating states of the first refrigeration unit, the second refrigeration unit, the ultracold refrigerator, the first water pump, the second water pump, the third water pump, and the nozzle control arm based on the standard operating parameters.

2. The autonomous ice sculpture printing system according to claim 1, wherein a quick connector is disposed at an inlet of the ice sculpture hose, and the cooling liquid tank is connected to the ice sculpture hose through the quick connector.

3. The autonomous ice sculpture printing system according to claim 1, wherein the ice sculpture is disposed in an ice sculpture printing area, an enclosure is disposed around the ice sculpture printing area, and the enclosure is configured to isolate the ice sculpture from an external environment and form a low-temperature environment; and
the ice sculpture comprises an ice sculpture shell and an ice sculpture interior, the ice sculpture shell is printed by the printing nozzle, and the ice sculpture interior is printed by the filling water nozzle.

4. The autonomous ice sculpture printing system according to claim 1, wherein the acquisition module comprises:
a first temperature sensor, disposed inside the purified water tank and the distilled water tank, and configured to detect the first real-time temperature of the purified water tank and the distilled water tank;
a second temperature sensor, disposed inside the printing nozzle, and configured to detect the second real-time temperature of the printing nozzle;
a flow rate sensor, disposed inside the printing nozzle, and configured to detect the real-time flow rate of the printing nozzle;
a third temperature sensor, disposed inside the ice sculpture hose, and configured to detect the third real-time temperature of the ice sculpture hose; and
a fourth temperature sensor, disposed around the ice sculpture, and configured to detect the fourth real-time temperature of the environment surrounding the ice sculpture.

5. The autonomous ice sculpture printing system according to claim 4, wherein the processing module is configured to analyze the operating data and set an operating state of the ice sculpture printing device, comprising:
the first real-time temperature is an average value of a water temperature in the purified water tank and a water temperature in the distilled water tank;
a cooling power of the first refrigeration unit is set based on the first real-time temperature;
a cooling power of the ultracold refrigerator is set based on the second real-time temperature;
an operating power of the second water pump is set based on the real-time flow rate; and
a cooling power of the second refrigeration unit is set based on the third real-time temperature and the fourth real-time temperature.

6. The autonomous ice sculpture printing system according to claim 5, wherein the processing module sets the cooling power of the first refrigeration unit based on the first real-time temperature, comprising:
determining whether the first real-time temperature is within a range of [0° C., 5° C.]; and skipping adjusting the cooling power of the first refrigeration unit if the first real-time temperature is within the range of [0° C., 5° C.]; or
determining a first temperature difference between the first real-time temperature and 0° C., and setting the cooling power of the first refrigeration unit based on the first temperature difference if the first real-time temperature is not within the range of [0° C., 5° C.].

7. The autonomous ice sculpture printing system according to claim 6, wherein the processing module sets the cooling power of the ultracold refrigerator based on the second real-time temperature, comprising:
comparing the second real-time temperature with −5° C.; and skipping adjusting the cooling power of the ultracold refrigerator if the second real-time temperature is lower than or equal to −5° C.; or
determining a second temperature difference between the second real-time temperature and −5° C., and setting the cooling power of the ultracold refrigerator based on the second temperature difference if the second real-time temperature is higher than −5° C.

8. The autonomous ice sculpture printing system according to claim 7, wherein the processing module sets the operating power of the second water pump based on the real-time flow rate, comprising:
determining a flow rate difference between the real-time flow rate and a preset flow rate;
setting the operating power of the second water pump based on the flow rate difference,
wherein a first flow rate difference, a second flow rate difference, and a third flow rate difference are preset, and the first flow rate difference, the second flow rate difference, and the third flow rate difference increase in turn;
setting the operating power of the second water pump based on a relationship among the flow rate difference and the first flow rate difference, the second flow rate difference, and the third flow rate difference;
setting the operating power of the second water pump to a first operating power P1 if the flow rate difference is less than the first flow rate difference;
setting the operating power of the second water pump to a second operating power P2 if the flow rate difference is greater than or equal to the first flow rate difference and less than the second flow rate difference;
setting the operating power of the second water pump to a third operating power P3 if the flow rate difference is greater than or equal to the second flow rate difference and less than the third flow rate difference; or
setting the operating power of the second water pump to a fourth operating power P4 if the flow rate difference is greater than or equal to the third flow rate difference, wherein P1<P2<P3<P4.

9. The autonomous ice sculpture printing system according to claim 8, wherein the processing module sets the cooling power of the second refrigeration unit based on the third real-time temperature and the fourth real-time temperature, comprising:
determining whether the fourth real-time temperature is less than 0° C.; if the fourth real-time temperature is lower than or equal to 0° C., determining a third temperature difference between the third real-time temperature and a standard temperature, and determining the cooling power of the second refrigeration unit based on the third temperature difference; or
if the fourth real-time temperature is greater than 0° C., determining a third temperature difference between the third real-time temperature and a standard temperature, determining a temperature sum between the third temperature difference and the fourth real-time temperature, and determining the cooling power of the second refrigeration unit based on the temperature sum.

10. An autonomous ice sculpture printing method, used in the autonomous ice sculpture printing system according to claim 1, wherein the method comprises:
acquiring operating data of an ice sculpture printing device, wherein the operating data comprises a first real-time temperature of a purified water tank, a second real-time temperature and a real-time flow rate of a printing nozzle, a third real-time temperature of an ice sculpture hose, and a fourth real-time temperature of an environment surrounding an ice sculpture;
analyzing the operating data to set an operating state of the ice sculpture printing device; and
controlling the ice sculpture printing device based on the set operating state,
wherein the analyzing the operating data to set an operating state of the ice sculpture printing device comprises:
a cooling power of the first refrigeration unit is set based on the first real-time temperature;
a cooling power of the ultracold refrigerator is set based on the second real-time temperature;
an operating power of the second water pump is set based on the real-time flow rate; and
a cooling power of the second refrigeration unit is set based on the third real-time temperature and the fourth real-time temperature.
